(19) United States
(12) Patent Application Publication
(10) Pub. No.: US 2016/0066176 A1
(43) Pub. Date: Mar. 3, 2016

(54) SYSTEM AND METHOD TO AVOID TRANSMITTING DOWNLINK CONTROL SIGNAL IN PRESENCE OF POSITIONING SIGNAL

(71) Applicant: ZTE (USA) INC., Richardson, TX (US)

(72) Inventor: Wenfeng ZHANG, Plano, TX (US)

(21) Appl. No.: 14/784,928

(22) PCT Filed: Apr. 16, 2014
(86) PCT No.: PCT/US2014/034310

§ 371 Date: Oct. 15, 2015

Related U.S. Application Data
(60) Provisional application No. 61/812,649, filed on Apr. 16, 2013.

(51) Int. Cl. H04W 8/12; H04W 72/04; H04W 8/20; G01S 5/10

(52) U.S. Cl. CPC H04W 8/12; G01S 5/10; H04W 72/042; H04W 8/205

(57) ABSTRACT

A method is performed at a base station for transmitting ePDCCH to a user equipment. The method includes: selecting a user equipment within a service area of the base station; determining PRS configuration information that is configured with the user equipment; and choosing a strategy for transmitting ePDCCH to the user equipment in accordance with the determination of the PRS configuration information configured with the user equipment.

### TECHNICAL FIELD

The present application relates to wireless telecommunication networks and, in particular, to a method to prevent the loss of downlink control signaling caused by transmission collision between downlink control signaling and positioning reference signal.

### BACKGROUND

Location based services (LCS) brings convenience and new services to subscribers of mobile communication networks and therefore generates significant revenues to the operators. LCS requires the integration of wireless network infrastructure, mobile stations (also known as “user equipment”, or “UE” in short), and a range of location-specific applications and content. Besides the utilization of build-in satellite GPS chipset inside a UE, the UE locating technology may utilize the downlink wireless reference signals specifically designed for the UE geographic locating service. One challenge with using the downlink wireless reference signals for locating a UE is that such reference signals may collide with other downlink control signaling, resulting the potential loss of the other downlink control signaling.

### SUMMARY

The above deficiencies and other problems associated with using the downlink wireless reference signals for locating a UE are reduced or eliminated by the invention disclosed below. In some embodiments, the invention is implemented in a base station (also known as “eNB”) that has one or more processors, memory and one or more modules, programs or sets of instructions stored in the memory for performing multiple functions. Instructions for performing these functions may be included in a computer program product configured for execution by one or more processors.

One aspect of the present application is a method performed at a base station for transmitting ePDCCH to a user equipment. The method includes: selecting a user equipment within a service area of the base station; determining Positioning Reference Signal (PRS) configuration information configured with the user equipment; and choosing a strategy for transmitting ePDCCH to the user equipment in accordance with the determination of the PRS configuration information configured with the user equipment. In some embodiments, if the user equipment is configured with the PRS configuration information and the user equipment is in an OTDOA positioning service session, the base station identifies PRS subframes in accordance with the PRS configuration information and transmits the ePDCCH to the user equipment in any subframe allocated for the user equipment that is not one of the PRS subframes. But if the user equipment is not configured with the PRS configuration information or not in an OTDOA positioning service session, the base station transmits the ePDCCH to the user equipment in any subframe allocated for the user equipment. In some other embodiments, the base station identifies a set of PRS subframes in accordance with the PRS configuration information of all the user equipments within the service area of the base station and transmits the ePDCCH to the user equipment in any subframe allocated for the user equipment that is not one of the set of PRS subframes.

Another aspect of the present application is a base station including one or more processors, memory, and one or more program modules stored in the memory and executed by the one or more processors. The one or more program modules further including instructions for: selecting a user equipment within a service area of the base station; determining Positioning Reference Signal (PRS) configuration information configured with the user equipment; and choosing a strategy for transmitting ePDCCH to the user equipment in accordance with the determination of the PRS configuration information configured with the user equipment. In some embodiments, if the user equipment is configured with the PRS configuration information and the user equipment is in an OTDOA positioning service session, the base station identifies PRS subframes in accordance with the PRS configuration information and transmits the ePDCCH to the user equipment in any subframe allocated for the user equipment that is not one of the PRS subframes. But if the user equipment is not configured with the PRS configuration information or not in an OTDOA positioning service session, the base station transmits the ePDCCH to the user equipment in any subframe allocated for the user equipment. In some other embodiments, the base station identifies a set of PRS subframes in accordance with the PRS configuration information of all the user equipments within the service area of the base station and transmits the ePDCCH to the user equipment in any subframe allocated for the user equipment that is not one of the set of PRS subframes.

### BRIEF DESCRIPTION OF DRAWINGS

For a better understanding, reference should be made to the following detailed description taken in conjunction with the accompanying drawings, in which:

FIG. 1 is a block diagram illustrating the transmission of PRS subframes in LTE according to some embodiments of the present application;

FIG. 2 is a block diagram illustrating a wireless network system supporting the transmission of both ePDCCH and PRS according to some embodiments of the present application;

FIG. 3 is a block diagram illustrating one example of ePDCCH loss caused by the transmission of PRS according to some embodiments of the present application; and

FIGS. 4A to 4E are flow charts illustrating methods of avoiding transmitting the ePDCCH in the presence of PRS according to some embodiments of the present application.

Like reference numerals refer to corresponding parts throughout the drawings.

### DETAILED DESCRIPTION

Reference will now be made in detail to various implementations, examples of which are illustrated in the accompanying drawings. In the following detailed description, numerous specific details are set forth in order to provide a thorough understanding of the present disclosure and the described implementations herein. However, implementations described herein may be practiced without these specific details. In other instances, well-known methods, procedures, components, and mechanical apparatus have not been described in detail so as not to unnecessarily obscure aspects of the implementations.

In LTE, downlink positioning reference signal (PRS) is designed to support downlink UE positioning algorithms based on observed time difference of arrival (OTDOA). In OTDOA, a number of (say M, usually M≧4) base stations or so-called eNBs broadcast PRS signals to a UE. One of the eNBs transmitting PRS is considered as the reference eNB for the UE. The UE measures the arrival timing difference between the PRS sent from the reference eNB and the PRS sent from the other non-reference eNBs. The UE sends these M-1 arrival timing differences to a network unit called Enhanced Serving Mobile Location Centre (E-SMLC), which calculates the geo-location of the UE based on the received measurements as well as the geographic coordination of the M eNBs that send the PRS signals. Note that not every eNB is capable of transmitting PRS. In this application, the eNB transmitting the PRS is called “OTDOA-functional eNB”, while the eNB never transmitting PRS is called “non-OTDOA-functional eNB”. The subframe (the minimum transmission time interval unit in LTE) that contains PRS signal is called “PRS-subframe”, while the subframe that does not contain PRS is called “non-PRS subframe”.

In order to support the OTDOA measurements, the UE also receives assistance data, including but not limited to, the PRS configuration parameters associated with the eNBs. The UE performs these measurements during a given period of time (typically up to 8 or 16 periods of the PRS signals) and reports to the E-SMLC these estimated time differences together with an estimate of the measurement quality. The E-SMLC then, using these time difference estimates, the knowledge of the eNBs' positions and transmit time offsets, estimates the position of the UE. In other words, a UE-assisted positioning technique includes at least two steps: (i) the UE makes some radio signal measurements, and (ii) the network determines the UE location (e.g., latitude and longitude) by processing the measurements reported by the UE.

The PRS are sent in a configurable number of consecutive subframes, which could be just one subframe or as many as 5 subframes. The E-UTRAN configures the PRS bandwidth (e.g., a certain number of resource blocks) and the periodicity of the PRS (e.g., one PRS occurrence every 160 subframes). Within a subframe containing the PRS, the PRS are transmitted on more subcarriers and more OFDM symbols when compared to the regular eNB-specific reference signals being sent on an antenna. Utilization of more time-frequency resources within a subframe by the PRS can improve the quality of the UE measurements compared to the use of only the basic eNB-specific reference signals. A pseudo-random sequence is sent on the PRS, and, this sequence is a function of numerous factors such as PCI (Physical layer Cell Identity), slot number, OFDM symbol number, and the value of Cyclic Prefix. The UE observes the PRS from different eNBs in the neighborhood and makes certain measurements. Examples of such measurements include RSTD (Reference Signal Time Difference), which is the relative timing difference between a neighbor eNB and the reference eNB. The E-UTRAN processes these OTDOA measurements from the UE in an implementation-specific and non-standardized manner to estimate the UE's location.

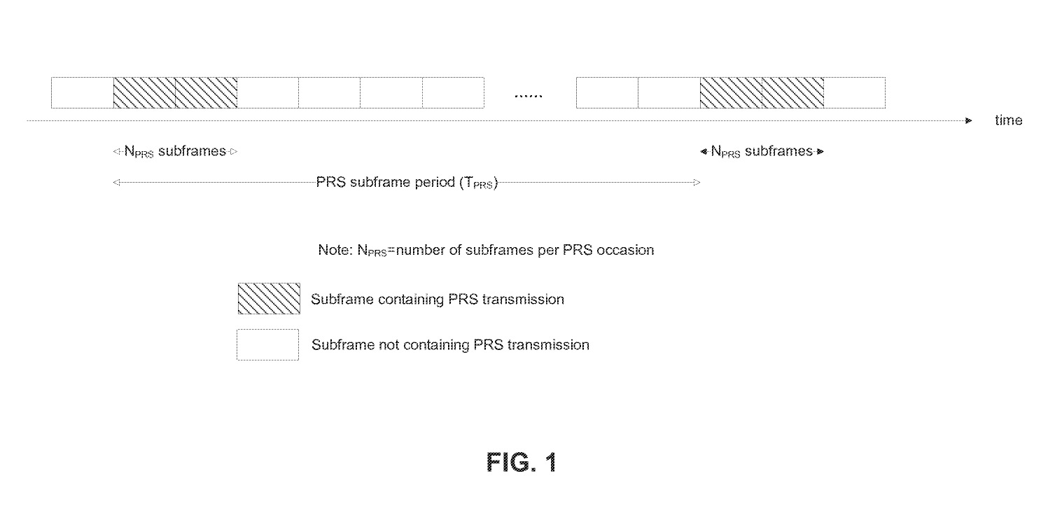

As noted above, in order for the UE to receive and measure the PRS, the UE should be firstly configured with PRS parameters, either explicitly or implicitly. In LTE, these parameters include:
The cyclic prefix (CP) of a PRS subframe, which can be either normal-CP or extended-CP;
The number of consecutive PRS subframes that are contained in one PRS occasion, which is shown as NPRB=2 for example in FIG. 1; and
The subframe period (T_{PRS}) and subframe offset (Δ_{PRS}) of the first PRS subframe in each PRS occasion. Assume the time-domain index of the first PRS subframe of each PRS occasion is t in unit of subframe, then t is determined by equation (t−Δ_{PRS}) mod T_{PRS}=0. Here both T_{PRS} and Δ_{PRS} are in unit of subframe, and are defined in one lookup table indexed by PRS configuration index (I_{PRS}), as shown in Table 1.

TABLE 1
PRS configuration lookup table

| PRS configuration | PRS periodicity T_{PRS} | PRS subframe offset Δ_{PRS} |
|---|---|---|
| Index I_{PRS} | (subframes) | (subframes) |
| 0-159 | 160 | I_{PRS} |
| 160-479 | 320 | I_{PRS} - 160 |
| 480-1119 | 640 | I_{PRS} - 480 |
| 1120-2399 | 1280 | I_{PRS} - 1120 |

The OTDOA positioning protocol defined in LTE has two kinds of protocol transparency:
LTE Positioning Protocol (LPP) transparency: The PRS configuration information above is originated by E-SMLC and packed into a data packet called “LPP-PDU” that is sent to UE via eNB. In some embodiments, the eNB does not have the capability to interpret the content of LPP-PDU, but just behaves like a message carrier. Therefore the UE's PRS configuration knowledge is transparent to the eNB.
LTE Positioning Protocol Annex (LPPa) transparency: the serving eNB of a UE, whether it transmits its own PRS or not, may not be able to know all the PRS subframes (from multiple neighboring OTDOA-functional eNBs) that are configured to any UE served by the serving eNB. This is because the LPPa protocol between eNB and E-SMLC does not support the eNB, regardless of its OTDOA capability, to query E-SMLC about the PRS transmission parameters used by other OTDOA-functional eNB.

These two kinds of protocol transparency may cause some problems when working with enhanced Physical Downlink Control CHannel (ePDCCH).

In some embodiments, a subframe in LTE is partitioned into two regions in the time domain: the first 2-4 OFDM symbols in the subframe construct the PDCCH (physical downlink control channel) region, while the rest of OFDM symbols in the subframe construct the PDSCH (physical downlink shared channel) region. The PDCCH region typically carries the physical layer control signaling including the downlink/uplink scheduling command, and the PDSCH region is used to carry downlink traffic data. The PRS is transmitted in the PDSCH region, but not in the PDCCH region. With the release 11 of LTE, ePDCCH was created. Note that ePDCCH can carry the same control information as conventional PDCCH, including downlink/uplink scheduling command. Like PRS, ePDCCH is transmitted in the PDSCH region but not in the conventional PDCCH region. But UE does not check both PDCCH and ePDCCH in the same subframe to find UE-specific downlink/uplink scheduling command. Instead, each UE is configured with one ePDCCH-monitoring bitmap of 20 or 40 bits, which informs the UE of the subframes the UE should monitor for ePDCCH and the rest subframes it should monitor for PDCCH.

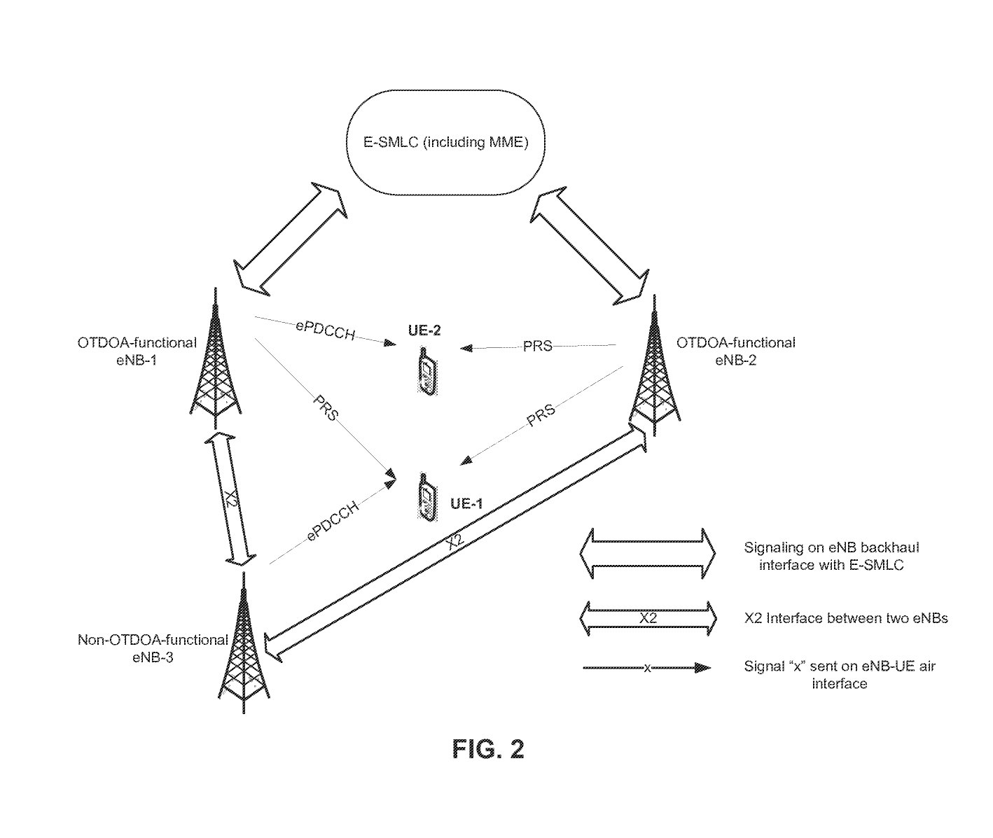

In a typical wireless communication system (such as LTE) with the UE positioning function enabled, one UE can receive control signaling (such as PDCCH or ePDCCH) from its serving eNB and also the PRS signal from its OTDOA-functional eNB. One example of such UE reception is shown in FIG. 2. As shown in the figure, the UE-1 receives ePDCCH from the non-OTDOA-functional eNB-3 and PRS from the OTDOA-functional eNB-1 and the OTDOA-functional eNB-2, respectively. The UE-2 receives ePDCCH from the OTDOA-functional eNB-1 and PRS from the OTDOA-functional eNB-2, respectively. In such a system operation, one subframe configured to a UE (e.g., UE-1) for ePDCCH monitoring can happen to be the subframe in which the UE is also configured to receive PRS. Sometimes, the same UE cannot receive both PRS and ePDCCH in the same PDSCH region in certain circumstance, such as:
If PRS is transmitted with extended-CP by OTDOA-functional eNB (e.g. eNB-2) and ePDCCH is transmitted with normal-CP by the serving eNB (e.g., eNB-3), the UE's internal fast Fourier transform (FFT) module can only work on a single CP type, not both normal-CP and extended-CP at the same time due to the implementation restriction; and
If the serving eNB (e.g., eNB-1) transmits both ePDCCH and PRS in the same subframe, the two signals may collide in the same PDSCH region.

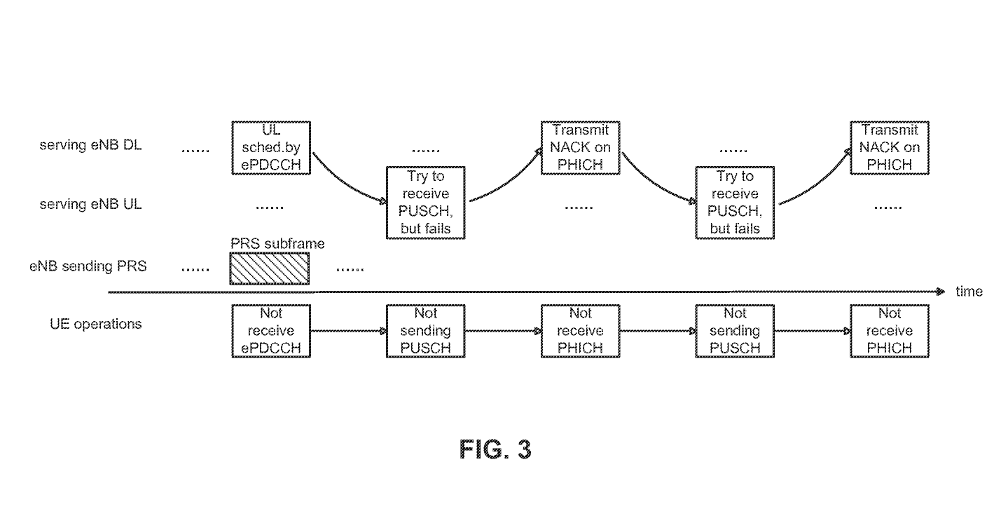

When there is a signal collision, PRS transmission and reception are prioritized over ePDCCH transmission and reception because PRS is the common signal that supports cell-wise UE positioning functionality, which would result the loss of the ePDCCH. FIG. 3 shows one problem caused by the signal collision in which the UE 300 cannot detect the ePDCCH in the PRS subframe. As shown in the figure, the serving eNB 100 transmits ePDCCH in its downlink and expects to receive the response from the UE 300 in the uplink. At the same time, another eNB 200 sends PRS to the UE 300. If the UE observes the configuration of both PRS reception and ePDCCH monitoring in the same subframe (as highlighted by the rectangular box), the UE 300 would have to drop the ePDCCH monitoring for the eNB 100 and only maintain the PRS reception for the eNB 200. However, the eNB 100 that transmits the ePDCCH does not know this UE 300 behavior on dropping of ePDCCH because the transparency on LPP protocol and LPPa protocol prevents the eNB 100 from apprehending the following two facts:
A PRS signal is sent in the same subframe that the eNB 100 uses to send the ePDCCH; and
The UE 300 is configured to receive PRS in that particular subframe and drop the ePDCCH.

In light of the above, the serving eNB 100 can avoid the signal collision by ceasing its ePDCCH transmission in that subframe if it gains any of above two types of information. Otherwise, the eNB 100 transmits the ePDCCH which is dropped by the UE 300, as shown in FIG. 3. Here the corresponding ePDCCH is referred to as “lost”. If the lost ePDCCH contains the scheduling command for data transmission on the physical uplink shared channel (PUSCH), the eNB 100 will find that it cannot receive PUSCH at the scheduled uplink subframe because the UE 300 does not transmit any PUSCH at that subframe. This PUSCH failure triggers the negative acknowledgement sent on the Physical Hybrid-ARQ Indicator Channel (PHICH) within the uplink HARQ process, which requests the UE 300 to re-transmit the failed data packet. But since the UE 300 has no knowledge about the PUSCH initial transmission, it would not attempt to detect the re-transmission requested by the eNB 100. Therefore, as shown in FIG. 3, the eNB 100 repeatedly transmits to the UE 300 the negative acknowledgements that are all ignored by the UE 300, because the UE 300 loses the first scheduling command carried by the lost ePDCCH.

The previous analysis indicates that, if the serving eNB 100 can obtain any of following two types of PRS configuration information, it can avoid transmitting ePDCCH in the subframe where the UE 300 attempts to detect PRS signal from the eNB 200 so that the loss of ePDCCH is avoided:
Information type-a: the target UE's knowledge of PRS. Here the target UE refers to the UE whose ePDCCH is served by the eNB; or
Information type-b: the information of the PRS transmissions that is configured to any UE whose ePDCCH is served by the eNB.

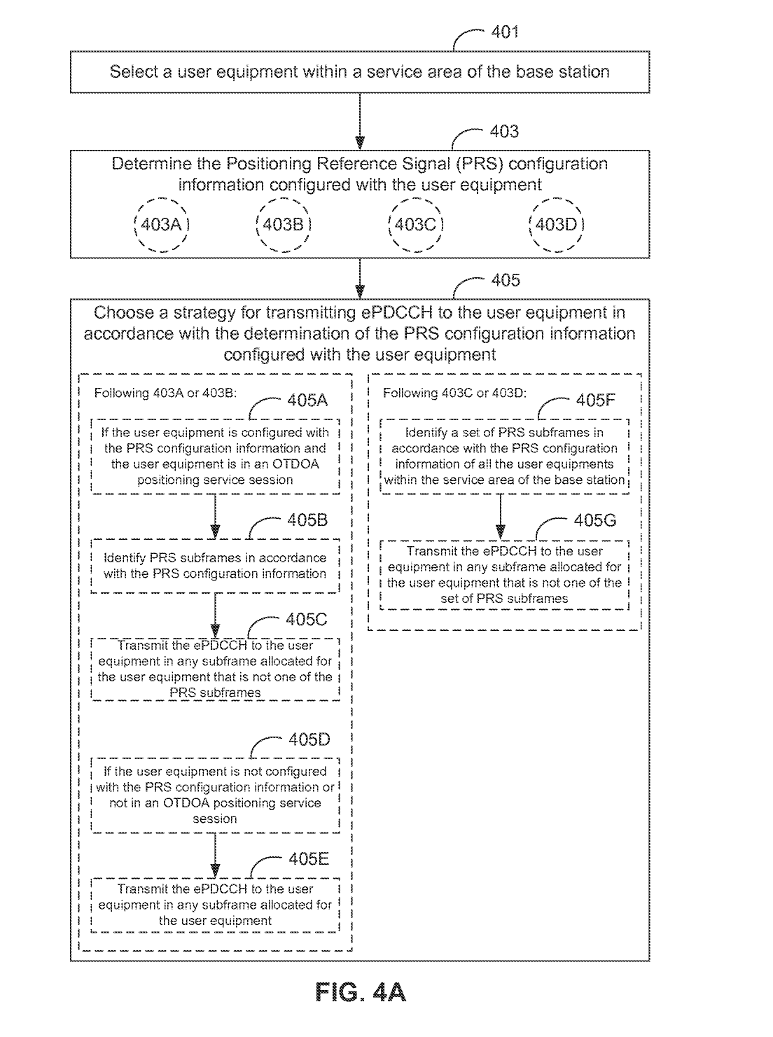

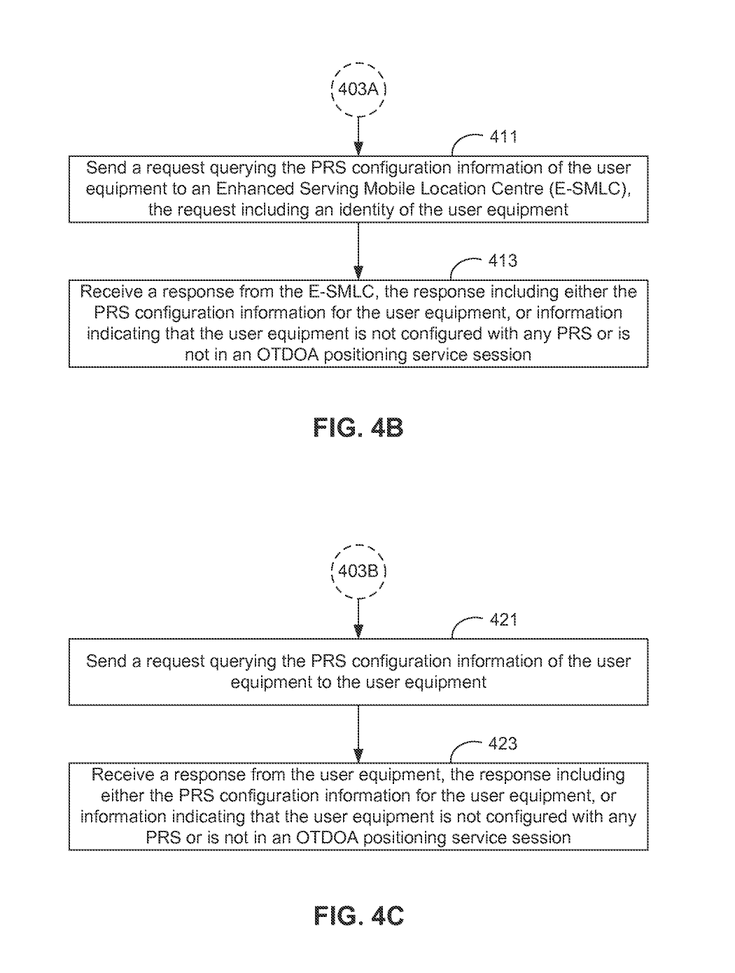

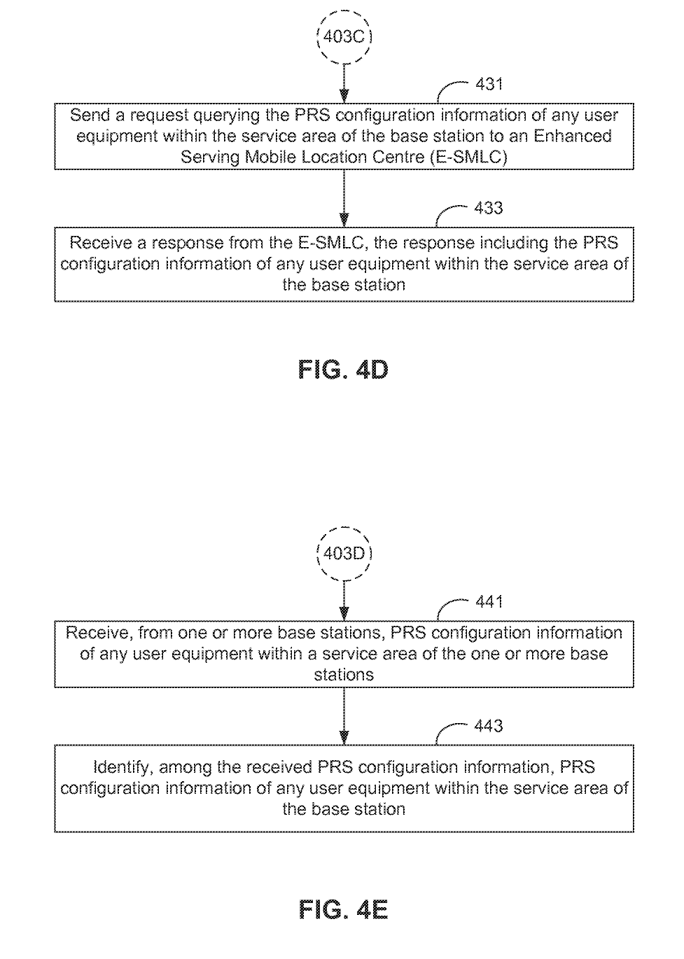

FIGS. 4A to 4E are flow charts illustrating methods of the eNB avoiding transmitting the ePDCCH to the UE in the presence of PRS according to some embodiments of the present application. As shown in FIG. 4A, the eNB selects (401) a user equipment within a service area of the eNB and then determines (403) the PRS configuration information that is configured at the user equipment. Based on the determination of the PRS configuration information configured at the user equipment, the eNB chooses (405) a strategy for transmitting ePDCCH to the user equipment in accordance with the determination of the PRS configuration information configured with the user equipment.

Note that the information type-a above is per-UE wise. What the eNB obtains is the PRS configuration information for one particular UE. As shown in FIGS. 4B and 4C, the eNB can obtain the information type-a by either consulting the E-SMLC that configures the corresponding UE with PRS reception or directly communicating with the corresponding UE.

As shown in FIG. 4B, the consulting with E-SMLC can be done on a request-response manner. The eNB sends (411) a request querying the PRS configuration information of the user equipment to the E-SMLC, the request including an identity of the user equipment. The E-SMLC sends (413) a response to the eNB, the response including either the PRS configuration information for the user equipment or information indicating that the user equipment is not configured with any PRS or is not in an OTDOA positioning service session. In some embodiments, both request from the eNB and response from the E-SMLC are carried in LPPa protocol data unit (PDU). As shown in FIG. 4A, if the information type-a reveals that the user equipment is configured with the PRS configuration information and the user equipment is in an OTDOA positioning service session (405A), the eNB then identifies (405B) PRS subframes in accordance with the PRS configuration information and transmit (405C) the ePDCCH to the user equipment in any subframe allocated for the user equipment that is not one of the PRS subframes. But if the information type-a reveals that the user equipment is not configured with the PRS configuration information or not in an OTDOA positioning service session (405D), the eNB then transmits (405E) the ePDCCH to the user equipment in any subframe allocated for the user equipment.

As shown in FIG. 4C, the direct communication with the corresponding UE can also be done on a request-response manner. The eNB sends (421) a request querying the PRS configuration information of the user equipment to the user equipment. The user equipment then returns (423) a response containing either the PRS configuration information for the user equipment, or information indicating that the user equipment is not configured with any PRS or is not in an OTDOA positioning service session. In some embodiments, both request from eNB and response from UE are carried in either MAC-CE information element or RRC signaling information element, both of which are transmitted over wireless air interface between eNB and UE. For example, if the information type-a reveals that the user equipment is configured with the PRS configuration information and the user equipment is in an OTDOA positioning service session (405A), the eNB then identifies (405B) PRS subframes in accordance with the PRS configuration information and transmit (405C) the ePDCCH to the user equipment in any subframe allocated for the user equipment that is not one of the PRS subframes. But if the information type-a reveals that the user equipment is not configured with the PRS configuration information or not in an OTDOA positioning service session (405D), the eNB then transmits (405E) the ePDCCH to the user equipment in any subframe allocated for the user equipment.

In some other embodiments, the direct communication with the corresponding UE can also be accomplished by UE actively sending the indication message to the eNB without any request from eNB. This indication message informs the receiving eNB of the most recent PRS configuration information and/or OTDOA positioning session status inside UE. Similarly, if no indication message is received by eNB for a particular UE, the eNB assumes that UE is not configured with any PRS or that the UE is not in any OTDOA positioning service session, which means the UE does not attempt to receive any positioning reference signal from any eNB. In this case, the eNB can send ePDCCH without being concerned about signal collision.

Note that the information type-b above is per-serving-area wise. What eNB obtains is the super-set of all PRS configuration information for any UE whose ePDCCH could be served by this eNB. The eNB can obtain information type-b by either consulting E-SMLC that makes all PRS configurations for all UEs within the geographic area or exchanging information with other eNBs.

As shown in FIG. 4D, the consulting with E-SMLC can be done on a request-response manner. The eNB sends (431) a request querying the PRS configuration information of any user equipment within the service area of the eNB to the E-SMLC. The E-SMLC returns (433) a response containing the PRS configuration information of any user equipment within the service area of the eNB. In some embodiments, both request from eNB and response from E-SMLC are carried in LPPa protocol data unit (PDU). As shown in FIG. 4A, upon receipt of the response, the eNB identifies (405F) a set of PRS subframes in accordance with the PRS configuration information of all the user equipments within the service area of the base station and then transmits (405G) the ePDCCH to the user equipment in any subframe allocated for the user equipment that is not one of the set of PRS subframes defined by the PRS configuration information.

As shown in FIG. 4E, the eNB receives (441), from one or more eNBs, PRS configuration information of any user equipment within a service area of the eNBs and identifies (443), among the received PRS configuration information, PRS configuration information of any user equipment within the service area of the eNB. As shown in FIG. 4A, upon receipt of the response, the eNB identifies (405F) a set of PRS subframes in accordance with the PRS configuration information of all the user equipments within the service area of the eNB and transmits (405G) the ePDCCH to the user equipment in any subframe allocated for the user equipment that is not one of the set of PRS subframes defined by the PRS configuration information.

During the information exchange with other eNBs, the eNB informs other eNBs of its latest knowledge of all UEs' PRS configurations it knows up-to-date. The information exchange starts with the OTDOA-functional eNBs reporting the configuration information of PRS they actually transmit. Then every time each eNB (not only OTDOA-functional eNB but also non-OTDOA-functional eNB) obtains the new knowledge of PRS configuration, it informs the new knowledge to other eNBs. In some embodiments, all the information exchanges between eNBs are performed on X2 interface.

Note that the two types of information have their own advantage over each other. For example, the obtaining of information type-a, which is per-UE wise, has the advantage that the information obtained is just sufficient for the eNB to ensure that the ePDCCH, which would otherwise have been transmitted to that UE, is not lost in a PRS subframe. In contrast, the obtaining of information type-b, which is per-serving-area wise, may result in more-than-necessary ePDCCH blocking. For example, assume the set of PRS subframes configured to a particular UE is represented by Ψ_{UE}, while the PRS subframes known by eNB via information type-b is represented by Ψ_{eNB}. In general, Ψ_{eNB} can be a super-set of Ψ_{UE}. Then the ePDCCH to the UE should have been received by the UE without any problem in the subframe x, where subframe x belongs to Ψ_{eNB} but not Ψ_{UE}, but the ePDCCH is indeed not transmitted by the eNB because the eNB blocks transmission of ePDCCH based on Ψ_{eNB} instead of Ψ_{UE}.

On the other hand, the obtaining of information type-b has the advantage that the supporting information flow does not occur very frequently, because the PRS transmissions in OTDOA-functional eNBs are very stable and rarely need to be reconfigured. Therefore the signaling overhead across the network backhaul to support the information type-b is minimal and the eNB behavior is easy to predict and control. In contrast, for information type-a may result in frequent signaling exchange over the network backhaul or even over the air interface, because the UE can be frequently reconfigured with new PRS due to the UE mobility and/or the UE can dynamically enter and quit from the OTDOA positioning service session. In some embodiments, an eNB obtains both types of information based on its specific need. For example, the eNB starts with obtaining the information type-b so that it can quickly gain knowledge of the PRS configuration information of the UEs within its service area. After that, the eNB may switch to obtain the information type-a when, e.g., a new UE is present in the service area. By doing so, the total bandwidth usage at the eNB can be reduced.

Throughout this application, it is assumed to have no technical difference between description “UE is configured with PRS” and the description “UE detects PRS based on the corresponding PRS configuration information”. If UE quits from OTDOA positioning service session, the PRS configuration that previously configured to this UE is no longer valid, and the UE is considered by this application to have no PRS configuration.

The above disclosures are merely preferred implementations of the present application, but are not intended to limit the scope of the claims of the present application. Any equivalent change made according to the claims of the present application modification still falls within the scope of the present application.

While particular implementations are described above, it will be understood it is not intended to limit the invention to these particular implementations. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present application. First ranking criteria and second ranking criteria are both ranking criteria, but they are not the same ranking criteria.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

1-22. (canceled)

23. A method for a base station to transmit ePDCCH to a user equipment, the method comprising:
selecting a user equipment within a service area of the base station;
determining Positioning Reference Signal (PRS) configuration information configured with the user equipment; and
choosing a strategy for transmitting ePDCCH to the user equipment in accordance with the determination of the PRS configuration information configured with the user equipment.

24. The method of claim 23, further comprising:
if the user equipment is configured with the PRS configuration information and the user equipment is in an OTDOA positioning service session:
identifying PRS subframes in accordance with the PRS configuration information; and
transmitting the ePDCCH to the user equipment in any subframe allocated for the user equipment that is not one of the PRS subframes;
if the user equipment is not configured with the PRS configuration information or not in an OTDOA positioning service session:
transmitting the ePDCCH to the user equipment in any subframe allocated for the user equipment.

25. The method of claim 23, wherein determining PRS configuration information configured with the user equipment further comprises:
sending a request querying the PRS configuration information of the user equipment to an Enhanced Serving Mobile Location Centre (E-SMLC), the request including an identity of the user equipment; and
receiving a response from the E-SMLC, the response including either the PRS configuration information for the user equipment or information indicating that the user equipment is not configured with any PRS or is not in an OTDOA positioning service session.

26. The method of claim 25, wherein the request from the base station and the response from the E-SMLC are carried in LPPa PDU.

27. The method of claim 23, wherein determining PRS configuration information configured with the user equipment further comprises:
sending a request querying the PRS configuration information of the user equipment to the user equipment; and
receiving a response from the user equipment, the response including either the PRS configuration information for the user equipment, or information indicating that the user equipment is not configured with any PRS or is not in an OTDOA positioning service session.

28. The method of claim 27, wherein the request from the base station and the response from the user equipment are carried in either MAC-CE information element or RRC signaling information element, both of which are transmitted over a wireless air interface between the base station and the user equipment.

29. The method of claim 27, wherein the base station assumes that the user equipment does not attempt to detect any OTDOA positioning reference signal if it does not receive a response from the user equipment.

30. The method of claim 23, wherein determining PRS configuration information configured with the user equipment further comprises:
the base station receives the PRS configuration information from the user equipment without sending any request to the user equipment.

31. The method of claim 23, wherein determining PRS configuration information configured with the user equipment further comprises:
sending a request querying the PRS configuration information of any user equipment within the service area of the base station to an Enhanced Serving Mobile Location Centre (E-SMLC); and
receiving a response from the E-SMLC, the response including the PRS configuration information of any user equipment within the service area of the base station.

32. The method of claim 31, further comprising:
identifying a set of PRS subframes in accordance with the PRS configuration information of all the user equipments within the service area of the base station;
transmitting the ePDCCH to a user equipment in any subframe allocated for the user equipment that is not one of the set of PRS subframes.

33. The method of claim 31, wherein the request from the base station and the response from the E-SMLC are carried in LPPa PDU.

34. The method of claim 23, wherein determining PRS configuration information configured with the user equipment further comprises:
receiving, from one or more base stations, PRS configuration information of any user equipment within a service area of the one or more base stations; and
identifying, among the received PRS configuration information, PRS configuration information of any user equipment within the service area of the base station.

35. The method of claim 34, wherein the PRS configuration information is exchanged between different base stations via X2 interface.

36. The method of claim 34, wherein the PRS configuration information exchange between different base stations starts with OTDOA-functional base stations reporting their PRS configuration information to other base stations such that, every time a base station receives updated PRS configuration information, it informs the updated PRS configuration information to other base stations.

37. The method of claim 23, where the PRS configuration information includes at least a cyclic prefix type, PRS configuration index and number of PRS subframes per PRS occasion.

38. A base station including one or more processors, memory, and one or more program modules stored in the memory and executed by the one or more processors, the one or more program modules further including instructions for:
selecting a user equipment within a service area of the base station;
determining Positioning Reference Signal (PRS) configuration information configured with the user equipment; and
choosing a strategy for transmitting ePDCCH to the user equipment in accordance with the determination of the PRS configuration information configured with the user equipment.

39. The base station of claim 38, wherein the one or more program modules further include instructions for:
when the user equipment is configured with the PRS configuration information and the user equipment is in an OTDOA positioning service session:
identifying PRS subframes in accordance with the PRS configuration information; and
transmitting the ePDCCH to the user equipment in any subframe allocated for the user equipment that is not one of the PRS subframes;
when the user equipment is not configured with the PRS configuration information or not in an OTDOA positioning service session:
transmitting the ePDCCH to the user equipment in any subframe allocated for the user equipment.

40. The base station of claim 38, wherein the one or more program modules further include instructions for:
sending a request querying the PRS configuration information of the user equipment to an Enhanced Serving Mobile Location Centre (E-SMLC), the request including an identity of the user equipment; and
receiving a response from the E-SMLC, the response including either the PRS configuration information for the user equipment or information indicating that the user equipment is not configured with any PRS or is not in an OTDOA positioning service session.

41. The base station of claim 38, wherein the one or more program modules further include instructions for:
sending a request querying the PRS configuration information of the user equipment to the user equipment; and
receiving a response from the user equipment, the response including either the PRS configuration information for the user equipment, or information indicating that the user equipment is not configured with any PRS or is not in an OTDOA positioning service session.

42. The base station of claim 38, wherein the one or more program modules further include instructions for:
sending a request querying the PRS configuration information of any user equipment within the service area of the base station to an Enhanced Serving Mobile Location Centre (E-SMLC); and
receiving a response from the E-SMLC, the response including the PRS configuration information of any user equipment within the service area of the base station.
